(19) United States
(12) Patent Application Publication
(10) Pub. No.: US 2026/0075381 A1
(43) Pub. Date: Mar. 12, 2026

(54) METHOD AND APPARATUS FOR MANAGING AUDIO IN A MULTI-SPEAKER ENVIRONMENT

(71) Applicant: SAMSUNG ELECTRONICS CO., LTD., Suwon-si (KR)

(72) Inventors: Ranjan Kumar SAMAL, Bangalore (IN); Rishabh GUPTA, Bangalore (IN); Somesh NANDA, Bangalore (IN)

(73) Assignee: SAMSUNG ELECTRONICS CO., LTD., Suwon-si (KR)

(21) Appl. No.: 19/368,699

(22) Filed: Oct. 24, 2025

Related U.S. Application Data
(63) Continuation of application No. PCT/KR2025/013981, filed on Sep. 9, 2025.

(30) Foreign Application Priority Data
Sep. 9, 2024 (IN) 202441067865
Jul. 28, 2025 (IN) 202441067865

(51) Int. Cl. H04S 7/00; G06F 3/01

(52) U.S. Cl. CPC H04S 7/304; G06F 3/017; H04S 2400/11; H04S 2400/15

(57) ABSTRACT

A method of managing audio in a multi-speaker environment, performed by a wearable audio device may be provided. The method may include generating, based on a binaural audio signal captured by the wearable audio device, a virtual sound source map indicating a localized position of one or more sources of sound. The method may include estimating, based on the virtual sound source map, one or more target sources indicating sources of sound of interest to a user of the wearable audio device. The method may include transmitting metadata associated with the wearable audio device, to an electronic device coupled to the wearable audio device, to cause the electronic device to refine the one or more target sources based on the metadata. The method may include receiving, from the electronic device, a processed audio signal associated with at least one refined target source.

### CROSS-REFERENCE TO RELATED APPLICATIONS

This application is a bypass continuation application of International Application No. PCT/KR2025/013981, filed on Sep. 9, 2025, which is based on and claims priority under 35 U.S.C. § 119 to Indian Patent Application number 202441067865 filed on Sep. 9, 2024 and Indian Patent Application number 202441067865 filed on Jul. 28, 2025, the disclosures of which are incorporated herein by reference in their entireties.

### TECHNICAL FIELD

The present disclosure generally relates to the field of wearable audio devices, and more particularly, relates to performing audio management in a multi-speaker environment based on interaction context.

### BACKGROUND

Wearable audio devices such as earbuds (or commonly referred to as “buds”) are one of the important electronic devices essential in the modern world. They enable a user to have personal audio experiences, facilitating people to enjoy music, podcasts, and calls privately and on the go. They enhance communication, entertainment, and productivity, offering convenience and comfort while minimizing noise disturbances in shared environments.

However, certain challenges are associated with the wearable audio devices such as balancing sound quality and environmental noise reduction. Due to their compact size, wearable audio devices struggle to deliver rich, immersive sound with deep bass and clear highs. Additionally, wearable audio devices often rely on existing noise isolation or active noise-cancellation technology to block out external sounds. However, these features can be limited in effectiveness, particularly in loud or unpredictable environments. Poor noise isolation can lead users to increase the volume to dangerous levels, potentially causing long-term hearing damage. Furthermore, active noise cancellation, while effective, can drain battery life quickly and may still not fully eliminate background noise, impacting the listening experience.

In addition to this, wearable audio devices are limited in their ability to interact with and adapt to the user's environment, particularly in social settings. They primarily function as passive audio playback devices, lacking a capability to understand the context of a conversation or prioritize important sounds. In multi-party conversations, this limitation becomes evident as wearable audio devices cannot distinguish between different sources of sound or determine which speaker should be emphasized. This can lead to difficulties in communication, where users may miss key parts of a discussion because the wearable audio devices fail to adjust to the dynamics of the conversation. Moreover, the inability to filter or prioritize sounds based on context means that background noise or less relevant voices can interfere with the user's ability to focus on the most critical elements of the interaction.

The information disclosed in this background of the disclosure section is only for enhancement of understanding of the general background of the disclosure and should not be taken as an acknowledgement or any form of suggestion that this information forms the prior art already known to a person skilled in the art.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

In an embodiment, a method of managing audio in a multi-speaker environment, performed by a wearable audio device may be provided. The method may include generating, based on a binaural audio signal captured by the wearable audio device, a virtual sound source map indicating a localized position of one or more sources of sound. The method may include estimating, based on the virtual sound source map, one or more target sources indicating sources of sound of interest to a user of the wearable audio device. The method may include transmitting metadata associated with the wearable audio device, to an electronic device coupled to the wearable audio device, to cause the electronic device to refine the one or more target sources based on the metadata. The method may include receiving, from the electronic device, a processed audio signal associated with at least one refined target source.

In an embodiment, a wearable audio device for managing audio in a multi-speaker environment may be provided. The wearable audio device may include a microphone, memory storing instructions, and at least on processor. The instructions, when executed by the at least one processor, individually or collectively, may cause the wearable audio device to generate, based on a binaural audio signal captured by the microphone, a virtual sound source map indicating a localized position of one or more sources of sound. The instructions, when executed by the at least one processor, individually or collectively, may cause the wearable audio device to estimate, based on the virtual sound source map, one or more target sources indicating sources of sound of interest to a user of the wearable audio device. The instructions, when executed by the at least one processor, individually or collectively, may cause the wearable audio device to transmit metadata associated with the wearable audio device to an electronic device coupled to the wearable audio device, to cause the electronic device to refine the one or more target sources based on the metadata. The instructions, when executed by the at least one processor, individually or collectively, may cause the wearable audio device to receive, from the electronic device, a processed audio signal associated with at least one refined target source.

In an embodiment, a computer-readable recording medium having at least one instruction recorded thereon, that, when executed by at least one processor, individually or collectively, may cause the wearable audio device to perform the method.

### BRIEF DESCRIPTION OF DRAWINGS

The accompanying drawings, which are incorporated in and constitute a part of this disclosure, illustrate an exemplary embodiment and, together with the description, serve to explain the disclosed principles. The same numbers are used throughout the figures to reference like features and components. An embodiment of at least one of device and methods in accordance with an embodiment of the present subject matter are now described, by way of example only, and with reference to the accompanying figures, in which:

FIG. 1 depicts an exemplary environment 100 in which an embodiment of the present disclosure may be implemented,

FIG. 2 depicts an architectural diagram 200 of a wearable audio device coupled to an electronic device for audio management in a multi-speaker environment, in accordance with an embodiment of the present disclosure,

FIG. 3 depicts a logic flow diagram 300 for audio management in a multi-speaker environment, in accordance with an embodiment of the present disclosure,

FIG. 4 depicts a logic flow diagram 400 for generation of a virtual sound source map, in accordance with an embodiment of the present disclosure,

FIG. 5 depicts a logic flow diagram 500 for estimation of one or more target sources, in accordance with an embodiment of the present disclosure,

FIG. 6 depicts an exemplary interaction timeline 600 of a user, in accordance with an embodiment of the present disclosure,

FIG. 7A depicts a logic flow diagram 700A for performing contact match, in accordance with an embodiment of the present disclosure,

FIG. 7B depicts an exemplary illustration 700B of a contact match table, in accordance with an embodiment of the present disclosure,

FIG. 8 depicts a logic flow diagram 800 for generation of conversation sequence and estimation of coarse target in accordance with an embodiment of the present disclosure,

FIG. 9 depicts a logic flow diagram 900 for refining a target source estimation, in accordance with an embodiment of the present disclosure,

FIG. 10 depicts, by way of a flowchart, an exemplary method 1000 for managing audio in a multi-speaker environment, in accordance with an embodiment of the present disclosure,

FIG. 11 depicts, by way of a flowchart, an exemplary method 1100 for managing audio in a multi-speaker environment, in accordance with an embodiment of the present disclosure, and

FIG. 12 illustrates a block diagram of an exemplary computer system 1200 for implementing an embodiment of the present disclosure.

### DETAILED DESCRIPTION

It may be advantageous to set forth definitions of certain words and phrases used throughout this patent document. The terms “transmit,” “receive,” and “communicate,” as well as derivatives thereof, encompass both direct and indirect communication. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE

HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the present document, the word “exemplary” is used herein to mean “serving as an example, instance, or illustration.” An embodiment or an implementation of the present subject matter described herein as “exemplary” is not necessarily to be construed as preferred or advantageous over other embodiments.

While the disclosure is susceptible to various modifications and alternative forms, an embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or operations does not include only those components or operations but may include other components or operations not expressly listed or inherent to such setup or device or method. In other words, one or more elements in a device or system or apparatus proceeded by “comprises . . . a” does not, without more constraints, preclude the existence of other elements or additional elements in the device or system or apparatus.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

In the following detailed description of an embodiment of the disclosure, reference is made to the accompanying drawings that form a part hereof, and in which are shown by way of illustration an embodiment in which the disclosure may be practiced. An embodiment is described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

As described in the background section, existing Wearable Audio Devices (WADs) may be limited in their ability to interact with and adapt to an environment of the user, particularly in social settings. The WADs may primarily function as passive audio playback devices, lacking the capability to understand the context of a conversation or prioritize important sounds. In multi-party conversations, this limitation may become evident as the WAD cannot distinguish between different sources of sound or determine which speaker should be emphasized. This may lead to difficulties in communication, where users may miss key parts of a discussion because the WAD fails to adjust to the dynamics of the conversation. Moreover, the inability to filter or prioritize sounds based on context may mean that background noise or less relevant voices can interfere with the ability of the user to focus on the most critical elements of the interaction.

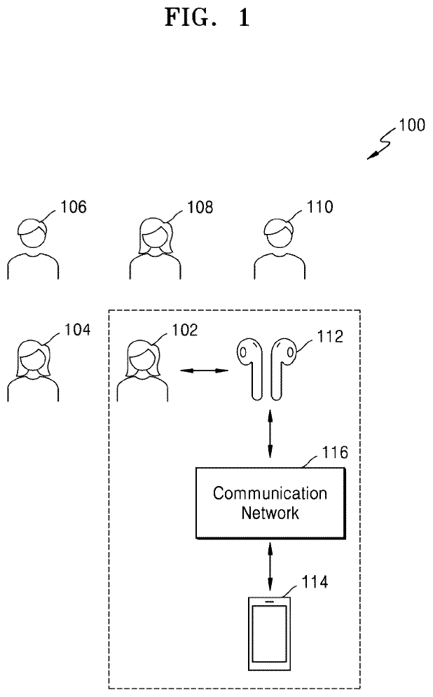

To overcome the above-mentioned limitations, the present disclosure may provide a WAD coupled to (e.g., in communication with) an electronic device (e.g., a mobile device) for audio management in a multi-speaker environment. The present disclosure may provide techniques to understand the interaction context in an ongoing voice interaction between multiple speakers. The interaction context may be utilized by the WAD to estimate target sources. An electronic device coupled to the WAD fine tunes or refines the estimated target sources and performs audio management of an audio signal based on the refined target sources. A detailed description is provided in the upcoming paragraphs in conjunction with FIGS. 1-9.

The present disclosure may generally relate to the field of Artificial Intelligence (AI), and more particularly to an apparatus and a method for managing audio in a multi-speaker environment using a wearable audio device by altering the playback of surrounding sounds based on an interaction context.

Therefore, there exists a need to overcome this problem as it highlights a significant gap in existing wearable audio device technology, underscoring the need for more intelligent, context-aware systems that can enhance real-world communication.

To address the above identified challenges, an embodiment of the present disclosure may provide an apparatus and a method for facilitating conversation assistance via wearable audio device (e.g., earbuds) by altering the playback of surrounding environment sounds based on interaction context. In particular, a non-limiting embodiment may include wearable audio device (e.g., earbuds) coupled to a user's electronic device (e.g., via Bluetooth). The wearable audio device may feature a virtual sound source map module and a coarse target source estimation model, supported by metadata that may include binaural audio signals, head position, and speaker embedding among others. The wearable audio device may capture audio signal, and the audio signal may be transmitted to the electronic device, where it may get converted to text using a speech-to-text generator module. The text may be processed by an AI command processor, which may use conversation sequence and signal filtering modules to enhance relevant speech and reduce background noise. The processed audio signal may then be sent back to the wearable audio device for playback, ensuring that the user hears prioritized conversation speech, improving communication in noisy or dynamic environments.

In an embodiment, a user may be in possession of a wearable audio device such that the wearable audio device may be able to perform the method being proposed by the present disclosure. The wearable audio device may be operating in connection with that of the electronic device (e.g., the mobile device) of the user. In a non-limiting embodiment, the connection between the wearable audio device and the electronic device may be established via Bluetooth (BT). The wearable audio device may include a virtual sound source map module and a coarse target source estimation model along with the metadata associated with the wearable audio device. In a non-limiting embodiment, the metadata may include at least one of binaural audio signal, target sources, head position of the user, or speaker embedding and virtual sound source map. The metadata may be transferred to the electronic device of the user via the BT such that it may be converted into text format via speech to text generator module. This speech to text generator module may send the generated text to an AI command processor which processes the received text. The discussed processing may be, in a non-limiting embodiment, facilitated by a conversation sequence and plan graph module and a fine target source estimation module in combination with signal filter management module. The processed audio signal may be transferred from the electronic device of the user to the wearable audio device as a playback processed audio signal. Therefore, the wearable audio device may reduce all irrelevant sounds for the context and boosts the conversation speech based on auto setting or explicit commands.

In an embodiment, a virtual sound source map module may generate a virtual sound source map. The virtual sound source map may be a 3D space where the wearable audio device may localize the sources of sound and estimate the direction of the conversation e.g., virtual sound source map module may use the direction of sound, along with the localization information to plot the points in the 3D space. The sound (e.g., speech) estimations may be used for generating identification embedding. The virtual sound source map module may comprise a sound source direction estimation module, a source embedding estimation module and head sensors. In a non-limiting embodiment, the head sensors may be used for head direction estimation and head gesture estimation of the user. In a non-limiting embodiment, the sound source direction estimation module may be used for azimuth and elevation estimation via the azimuth and elevation estimation module. The outputs from the azimuth and elevation estimation module, the source embedding estimation module and the head gesture estimation may be combined to facilitate generating the virtual sound source map by rendering and serializing the virtual sound source map in a three-dimensional space.

An embodiment of the technique of map rendering and serialization in a 3D space is described herein. In an embodiment, user may be wearing the wearable audio device and the head direction of user wearing wearable audio device may be determined. Further, another person may be in conversation with other people such that direction of the conversation may be depicted as shown in the 3D space. This generated virtual sound source map may be further used by the coarse target source estimation model.

In an embodiment, coarse target estimation is described. As already explained, the virtual sound source map may be input into the target source estimation module. Now, the output from the map rendering and serializing may be fed to the direction of conversation estimation module of the target source estimation module. In addition to this, one or more hand gestures of the user may be estimated using one or more head sensors associated with the wearable audio device. For example, head sensors of the coarse target source estimation model may take input from the user wearing the wearable audio device. The head sensors may facilitate head gesture estimation along with head position and direction estimation. The interaction timeline may be generated based on the head gestures, a head position of the user, and a head direction of the user. For example, data generated from estimation of both the head gesture along with head position and direction may be transferred, in combination, to the target detection AI model, which in turn may determine the user interaction timeline. The interactions between user and other people may be categorized. In a non-limiting embodiment, the interactions may be “direct” where the user would have direct eye contact with the other speaker in conversation. In a non-limiting embodiment, the interaction may be “indirect”, where the user may be listening and shaking head to acknowledge the conversation. In a non-limiting embodiment, the interaction may be “passive”, where the user may be engaged in the conversation but shows no sign of acknowledgement. In view of these interactions, the one or more target sources may be updated in response to a change in the head direction of the user. In other words, the target source estimation module may estimate the target source which may vary from time to time and accordingly updated whenever the head sensor may indicate any change in the direction of the user.

In an embodiment, generation of the wearable audio device metadata may be described. In an embodiment, the raw and processed information generated from both the earlier stages e.g., virtual sound source map, and target source estimation may be combined together with the original binaural audio signal to determine wearable audio device metadata (henceforth referred as metadata). The metadata may be sent to the electronic device of the user for further processing. In an embodiment, the speech to text generator module of the electronic device may convert the received speech into text format. In a non-limiting embodiment, the speech to text generator module may deploy Acoustic Speech Recognition (ASR) technique which is a deep learning-based signal processing model that may convert the incoming audio speech signal into text. Since it may be possible to have overlap speech from more than one user, the speech to text generator module may be needed to perform speech separation before performing or executing the ASR model. In an embodiment, the generated text via the speech to text generator module may be then sent to the AI command processor.

In an embodiment, the functioning of the AI command processor may be disclosed. In a non-limiting embodiment, the AI command processor may typically signify the virtual assistants. The AI agents may process the text generated from STT generator to identify if the spoken utterance is target for the AI agent to respond. That is, it may be possible that during the conversation, the user may request a command for the AI running on the electronic device. The command may be identified by the AI command processor and a response may be played to the user after processing the request and executing the action. The request may be only processed if the command was from the user. In an embodiment, the spoken text may be fed to the VA command classifier module of the AI command processor, which may classify whether an utterance from each user is an AI Command or general conversation. In an embodiment, the output from the VA command classifier module and the generated metadata may be fed to the speaker embedding generator and matcher module which, in turn, may be responsible to generate embedding from the audio speech signal corresponding to the spoken text per user. The generated embedding may match with the embeddings received as part of the metadata. The output of the speaker embedding generator and matcher module may then be fed to the contact matcher module which may look into the contact database of the electronic device and match the speaker embedding generated with the speaker embedding stored into the contact profile database. The stored speaker embedding may be manufactured by processing speech signals during a call or enrolled explicitly by the speaker. The output from the speaker embedding generator and matcher module may also simultaneously be fed to the action execution module which may execute the action only when the spoken utterance is an AI Command and is spoken by the user, the AI virtual assistant may process the command and execute the corresponding action. The action execution results may be modulated as vocal response from the AI and played back to the user via wearable audio device.

The above explained technique may be explained with the help of an exemplary non-limiting embodiment, where the spoken text may constitute of “I was telling you that. . . . Can you check my calendar for tomorrow and suggest when I'm free to meet Keyan. shall we meet tomorrow at 7 pm at hotel castle?” In this give sentence, there are 3 speakers involved, one of which is the user and other two speakers may be referred to as Person X and Person Y. The AI command processor may analyze the spoke sentences and determine that only one of them e.g., “Can you check my calendar for tomorrow and suggest when I'm free to meet Keyan” is an AI command and then the contact matcher module may match the voice with that of the contact database and determine by whom the sentence associated with the AI command was spoken. If the contact matcher module identifies that the AI command was given by the user then only it may execute the associated action. Once the AI command processor determines the associated AI command and determines the speaker of the same, this processed data may be then fed to the conversation sequence and plan graph module.

In an embodiment, the functioning of the conversation sequence and plan graph module may be disclosed. The generated metadata and the data received from the AI command processor may be fed to the conversation sequence estimation module. The output from the conversation sequence estimation module and the virtual sound source map may be fed to the coarse target association module. Both these modules e.g., the conversation sequence estimation module and the coarse target association module along with the planner module may create a conversation sequence graph which may be represented as a graph or a table in memory. In a non-limiting embodiment, carrying forward the exemplary scenario explain the foregoing paragraphs, when the metadata and the table generated by the AI command processor may be fed to the conversation sequence and plan graph module, it may process the same and create a conversation sequence graph by determining the coarse target association as depicted in table. An embodiment may provide an extension of the table received from the AI command processor determining the coarse target, sequence in the conversation and the overlap time of the sentences spoken by the speakers. The same information may also be represented in the form a graph. This information generated in form of table or graph may be fed to the fine target source estimation module.

In an embodiment, the functioning of the fine target source estimation module may be described. This module may be deployed to estimate the target with more detailed processing. In a non-limiting embodiment, fine target estimation may be performed at the electronic device of the user. The fine target source estimation module may intake the generated old plan graph, coarse targets, metadata, user interaction type, along with the user's body sensors to determine the actual interaction of the user and generate a new plan graph via the re-plan generator to effectively illustrate the actual persons among which the interaction is taking place. The new plan graph may be utilized by the signal filter management module.

In an embodiment, the functioning of the signal filter management module may be disclosed. This module may be responsible to use the new plan graph to estimate if the ongoing conversation is meaningful for the user, in a non-limiting embodiment. In a non-limiting embodiment, it may also determine if there is an active interaction with the user. In a non-limiting embodiment, it may also determine whether there is more than one simultaneous interaction with the user. These may be implemented by sound source classifier and separator module in conjunction with user command source filter module, where the user command source filter module may be referred to as stack of audio filters applied based on user's explicit command to change the audio sound. For example, user explicitly mentions to minimize background music. Based on the above conditions, the weighted source mixer module may separate and mix the separated sources of sound and send the final output to the user wearing the wearable audio device.

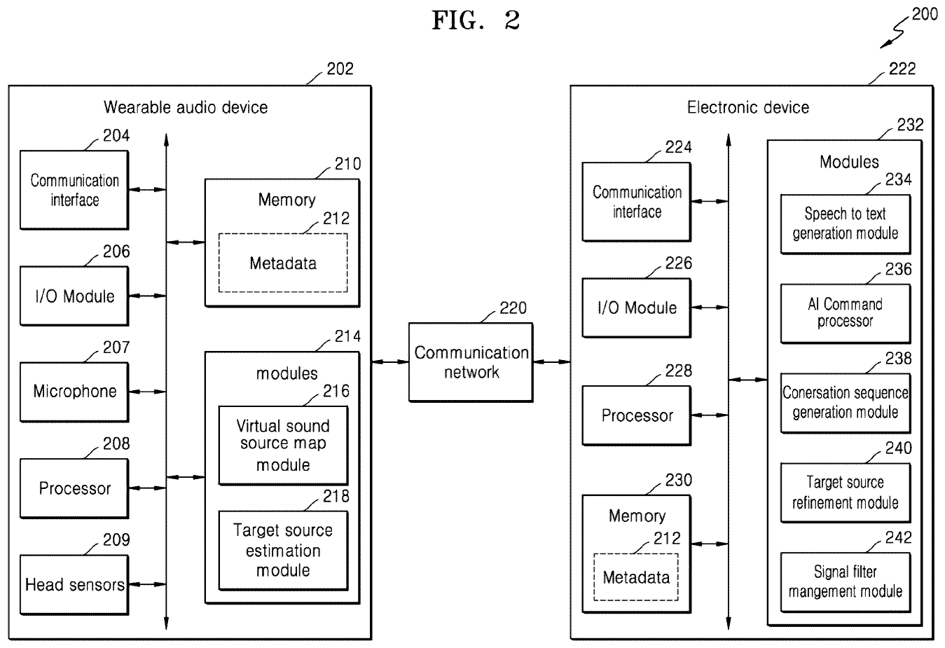

FIG. 1 depicts an exemplary environment 100 in which an embodiment of the present disclosure may be implemented. The exemplary environment 100 depicts a user 102 in a multi-speaker environment, e.g., the user 102 may be in communication with a plurality of speakers represented by reference numerals 104-110. The user 102 may be wearing a WAD 112. The WAD 112 may communicate with an electronic device (e.g., a mobile device) 114 associated with the user 102 via a communication network 116. In an exemplary embodiment, the communication network 116 may provide a wireless means of communication between the WAD 112 and the mobile device 116 such as Bluetooth®, Zigbee, and the like. The WAD 112 may perform management of audio signals of the plurality of speakers 104-110 interacting with the user 102. A detailed description of the functionalities of the WAD 112 and the electronic device 114 may be provided in the upcoming paragraphs in conjunction with FIGS. 2-9.

FIG. 2 depicts an architectural diagram 200 of a WAD coupled to an electronic device for audio management in a multi-speaker environment, in accordance with an embodiment of the present disclosure. In an embodiment, a WAD 202 (analogous to the WAD 112 depicted in FIG. 1) may be connected to an electronic device 222 (analogous to the electronic device 114 depicted in FIG. 1) via a communication network 220 (analogous to the communication network 116 depicted in FIG. 1).

In an embodiment, the WAD 202 may include a communication interface 204, an Input/Output (I/O) module 206, a microphone 207, a processor 208, one or more head sensors 209, a memory 210 and modules 214. It shall be noted that, in an embodiment, the WAD 202 may include more or fewer components than those depicted herein. The various components of the WAD 202 may be implemented using hardware, software, firmware, or any combinations thereof. Further, the various components of the WAD 202 may be operably coupled with each other. Various components of the WAD 202 may be capable of communicating with each other using communication channel media (such as buses, interconnects, etc.).

In an embodiment, the modules 214 may include a virtual sound source map module 216 and a target source estimation module 218. Further, the memory 210 may store metadata 212 associated with WAD 202.

In an embodiment, the electronic device 222 may include a communication interface 224, an Input/Output (I/O) module 226, a processor 228, a memory 230 and modules 232. It shall be noted that, in an embodiment, the electronic device 222 may include more or fewer components than those depicted herein. The various components of the electronic device 222 may be implemented using hardware, software, firmware, or any combinations thereof. Further, the various components of the electronic device 222 may be operably coupled with each other. Various components of the electronic device 222 may be capable of communicating with each other using communication channel media (such as buses, interconnects, etc.).

In an embodiment, the modules 232 may include a speech to text generation module 234, an Artificial Intelligence (AI) command processor 236, a conversation sequence generation module 238, a target source refinement module 240 and a signal filter management module 242. Further, the memory 230 may store metadata 212 received from the WAD 202.

In an embodiment, memories 210 and 230 may be capable of storing machine executable instructions. In an embodiment, the processors 208 and 228 may be embodied as executors of software instructions. As such, the processors 208 and 228 may be capable of executing the instructions stored in the memories 210, 230 respectively, to perform one or more operations described herein.

In an embodiment, the processors 208 and 228 may be embodied as multi-core processors, single core processors, or a combination of one or more multi-core processors and one or more single core processors. For example, the processors 208 and 228 may be embodied as one or more of various processing devices, such as a coprocessor, a microprocessor, a controller, a Digital Signal Processor (DSP), a processing circuitry with or without an accompanying DSP, or various other processing devices including, a Microcontroller Unit (MCU), a hardware accelerator, a special-purpose computer chip, or the like.

In an embodiment, the processors 208 and 228 may include one or a plurality of processors. The one or a plurality of processors may be a general-purpose processor, such as a Central Processing Unit (CPU), an Application Processor (AP), or the like, a graphics-only processing unit such as a Graphics Processing Unit (GPU), a Visual Processing Unit (VPU), and/or an AI-dedicated processor such as a neural processing unit (NPU).

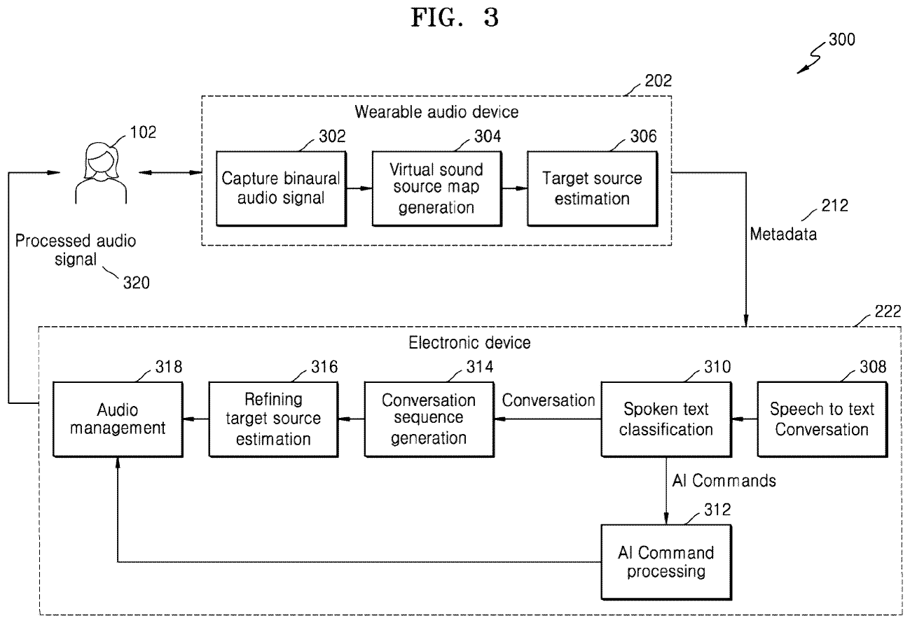

In an embodiment, the processors 208 and 228 in conjunction with the respective modules 214 and 232 may cause the WAD 202 and the electronic device 222 to perform various operations as depicted in FIG. 3 and elaborated in detail in the upcoming paragraphs.

FIG. 3 depicts a logic flow diagram 300 for audio management in a multi-speaker environment, in accordance with an embodiment of the present disclosure. In an embodiment, the logic blocks 302-306 may be performed by the WAD 202 and the logic blocks 308-318 may be performed by the electronic device 222. However, the bifurcation of functionalities between the WAD 202 and the electronic device 222 as described herein is merely exemplary and shall not be construed as limiting. In an embodiment, the WAD 202 may perform one or more functions disclosed in blocks 318-318.

At block 302, the logic flow diagram 300 describes capturing of a binaural audio signal by the WAD 202. In an embodiment, the binaural audio signal may be captured by the microphone 207 associated with the WAD 202. The binaural audio signal may be associated with one or more sources of sound. In an embodiment, the one or more sources of sound may include the user 102 of the WAD 202 and the plurality of speakers 104-110.

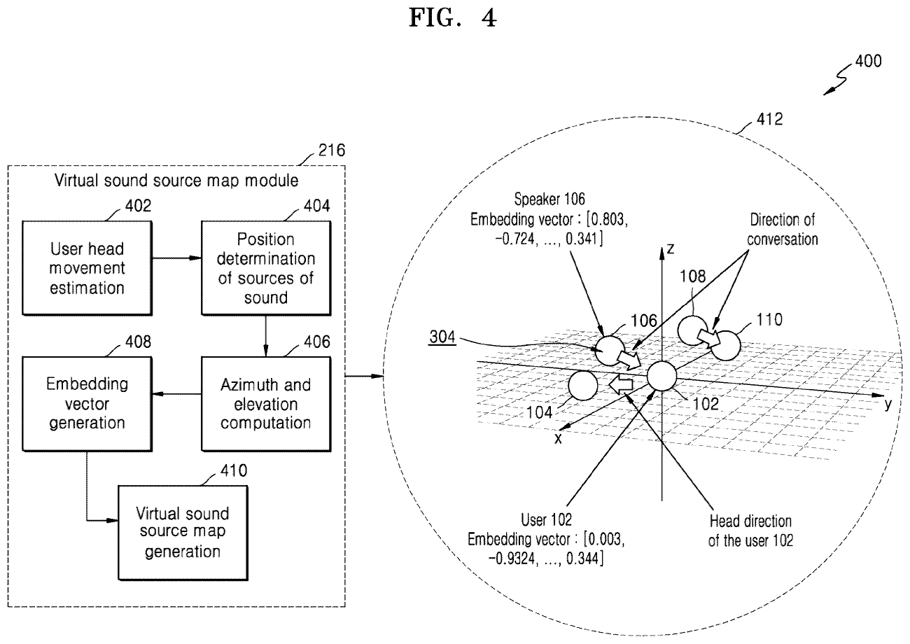

At block 304, the logic flow diagram 300 describes generating a virtual sound source map using the binaural audio signal. In an embodiment, the processor 208 in conjunction with the virtual sound source map module 216 may cause the WAD 202 to generate the virtual sound source map based on localizing the one or more sources of sound and estimating a direction of conversation among the user 102 and the plurality of speakers 104-110. The generation of the virtual sound source map is described herein in conjunction with FIG. 4.

FIG. 4 depicts a logic flow diagram 400 for generation of a virtual sound source map, in accordance with an embodiment of the present disclosure.

At block 402, the logic flow diagram 400 describes estimating a head movement of the user 102. In an embodiment, the WAD 202 may estimate the head movement based on data obtained from one or more head sensors 209 associated with the WAD 202.

At block 404, the logic flow diagram 400 describes determining relative positions of the one or more sources of sound with respect to the head movement of the user 102. In an embodiment, based on the head movement of the user 102, directions of sound (e.g., voice) from each of the plurality of speakers 104-110 may be estimated. The estimated direction of sound associated with each of the one or more sources may be used to assign a position to each of the one or more sources of sound in 3-Dimensional (3D) space.

At block 406, the logic flow diagram 400 describes computing azimuth angle and elevation for each of the one or more sources of sound. In an embodiment, the azimuth angle and elevation may be used to determine whether any of the one or more sources of sound are in motion. In an embodiment, to compute the azimuth angle and the elevation, the processor 208 in conjunction with the virtual sound source map module 216 may cause the WAD (202) to compute horizontal offset angles and vertical offset angles for the one or more sources of sound.

At block 408, the logic flow diagram 400 describes generating embedding vectors for the one or more sources of sound. In an embodiment, the embedding vectors may act as identifiers (IDs) for identification of the one or more sources of sound and hence may be unique for each of the one or more sources of sound. For instance, the embedding vector for the user 102 may be generated as [0.003, −0.9324, . . . , 0.344].

At block 410, the logic flow diagram 400 describes generating a virtual sound source map 412. In an embodiment, the virtual sound source map 412 may be generated based on the relative positions of the one or more sources of sound, the horizontal offset angles and the vertical offset angles, and the embedding vectors. In an embodiment, the virtual sound source map 412 may indicate localized positions of each of the one or more sources of sound in the 3D space. In an embodiment, the virtual sound map may be used to obtain directions of conversation for each of the one or more sources of sound, e.g., the user 102 and the plurality of speakers 104-110.

In an embodiment, for the generation of the virtual sound source map 412, the processor 208 in conjunction with the virtual sound source map module 216 may cause the WAD 202 to identify, using the binaural audio signal, one or more environmental sources of sound, including, but not limited to, ambient music, announcements over speakers, etc. In an embodiment, the one or more sources of sound may include the one or more environmental sources of sound. The one or more environmental sources of sound may be denoted on the virtual sound source map 412. The embedding vector for one or more environmental sources of sound may be generated.

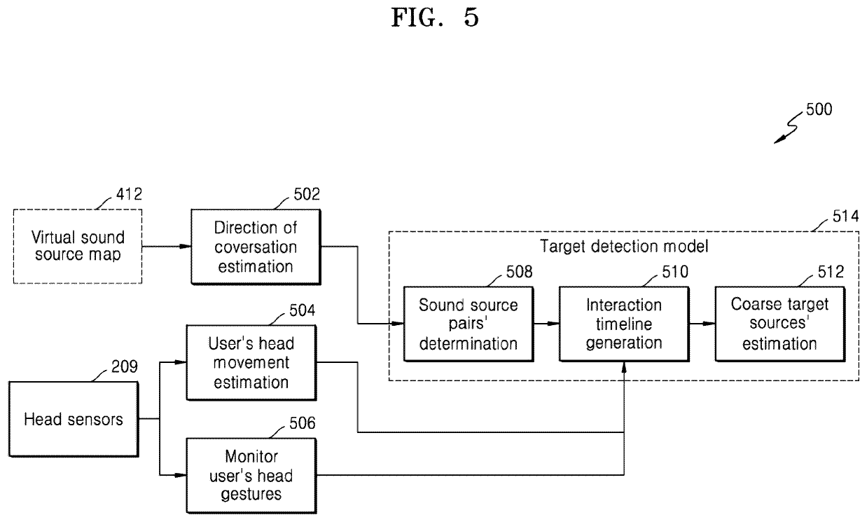

Referring again to FIG. 3, at block 306, the logic flow diagram 300 describes estimating one or more target sources for audio management. In an embodiment, the processor 208 in conjunction with the target source estimation module 218 may cause the WAD 202 to estimate one or more target sources, based on the generated virtual sound source map 412. In an embodiment, the one or more target sources may indicate sources of sound of interest to the user 102 (e.g., the ones for whom audio signals are to be processed or managed). The estimation of the one or more target sources is described herein in conjunction with FIG. 5.

FIG. 5 depicts a logic flow diagram 500 for estimation of one or more target sources, in accordance with an embodiment of the present disclosure.

At block 502, the logic flow diagram 500 describes estimating directions of conversation of the one or more sources of sound. In an embodiment, the direction of conversation of the one or more sources of sound may be estimated based on the generated virtual sound source map 412. In an embodiment, for estimating the direction of conversation, a trained AI model may be used. The inputs to the trained AI model may include a head direction of the user 102 and direction of the one or more sources of sound from the virtual sound source map 412. The trained AI model may output estimates of the directions of conversation for the one or more sources of sound based on the inputs. In an embodiment, the trained AI model may also assign priorities of the one or more sources of sound based on a direction of conversation of the one or more sources of sound with respect to the user 102, so that the one or more target sources may be selected based on the priorities and the interaction timeline.

At block 504, the logic flow diagram 500 describes estimating a relative head movement of the user 102. In an embodiment, data from the one or more head sensors 209 may be used to estimate a current direction of user's head with respect to its initial position. A change in the direction of user's head may indicate the head movement of the user 102.

At block 506, the logic flow diagram 500 describes monitoring one or more head gestures of the user 102. In an embodiment, data from the one or more head sensors 209 may be used by a pre-trained classification model to classify the head gestures of the user 102. The classification of the head gestures may include: an agreement gesture and a disagreement gesture. The classification of the head gestures may be used by the target source estimation module 218 to determine interaction of the user 102 with the one or more of the plurality of speakers 104-110, by associating the gesture with spoken voice associated with the one or more sources of sound.

At block 508, the logic flow diagram 500 describes determining one or more sound source pairs. In an embodiment, the determination of the one or more sound source pairs may be performed by a trained target detection model 514 implemented by the target source estimation module 218. In an embodiment, input of the target detection model 514 may include the estimated direction of conversation for the one or more sources of sound to estimate one or more sound source pairs amongst whom a live interaction is present. For instance, based on the estimated direction of conversation, the target detection model 514 may estimate the following one or more sound source pairs-user 102 and speaker 104, user 102 and speaker 106, speakers 108 and 110.

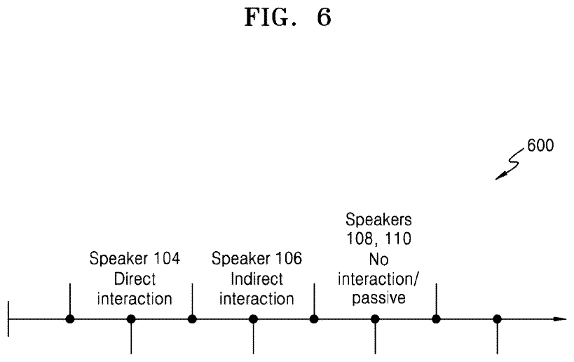

At block 510, the logic flow diagram 500 describes generating an interaction timeline of the user 102 with the one or more sources of sound (e.g., the plurality of speakers 104-110). In an embodiment, the generation of the interaction timeline may be performed by the target detection model 514. In an embodiment, input of the target detection model 514 may include the one or more sound source pairs, the relative movement of the head of the user 102 and the one or more monitored head gestures of the user 102 to generate the interaction timeline of the user 102. In an embodiment, the interaction timeline may indicate a time duration and a type of interaction of the user 102 with the one or more sources of sound. In an embodiment, the type of interaction may include at least one of: direct, indirect and passive. For example, the type of interaction may be determined to be direct, when the user 102 has a direct eye contact with another speaker during conversation. The type of interaction may be determined to be indirect, when the user 102 is listening and shaking head to acknowledge the conversation with another speaker. The type of interaction may be determined to be passive, when even though the user 102 may be engaged in a conversation but shows no sign of acknowledgement. An exemplary interaction timeline 600 of the user 102 associated with one or more sources of sound is depicted in FIG. 6. The exemplary interaction timelines 600 may indicate that the user 102 is in direct interaction with the speaker 104, in indirect interaction with the speaker 106 and in no/passive interaction with the speakers 108, 110. The exemplary interaction timelines 600 may indicate a time duration of the interaction.

Returning to FIG. 5, at block 512, the logic flow diagram 500 describes estimating coarse (or approximate) target sources associated with audio management. In an embodiment, the estimation of target sources may be performed by the target detection model 514. The target detection model 514 may estimate one or more target sources based on the interaction timeline. For instance, considering the exemplary interaction timeline 600 depicted in FIG. 6, the target detection model 514 may estimate the speaker 104 and speaker 106 to be the coarse target sources as the user 102 is interacting with them either directly or indirectly.

In an embodiment, upon estimating the one or more target sources, the processor 208 of the WAD 202 may transmit metadata 212 to the electronic device 222 as depicted in FIG. 3. In an embodiment, the metadata 212 may include, but not limited to, at least one of the binaural audio signal, the virtual sound source map 412, the one or more target sources, the interaction timeline of the user 102, the embedding vectors, or the head position of the user 102. The metadata 212 received by the electronic device 222 may be processed through the blocks 308-318 to generate processed audio signal 320 as described in the forthcoming paragraphs.

At block 308, the logic flow diagram 300 describes performing speech to text conversion. As described in the preceding paragraph, the metadata 212 received by the electronic device 222 may include the binaural audio signal. In an embodiment, the processor 228 associated with the electronic device 222 in conjunction with a speech to text generation module 234 may cause the electronic device 222 to process the binaural audio signal to generate a plurality of spoken texts. In an exemplary embodiment, the processor 228 may employ one or more preexisting speech to text conversion techniques for generating the plurality of spoken texts.

At block 310, the logic flow diagram 300 describes performing classification of the plurality of spoken texts. In an embodiment, the processor 228 may cause the electronic device 222 to classify each of the plurality of spoken texts as one of: a command for an AI-based Virtual Assistant (VA) and a conversation. Based on spoken texts classified as a conversation, the logic flow diagram may proceed to block 314. Based on spoken texts classified as commands for the AI-based VA, the logic flow diagram 300 may proceed to block 312.

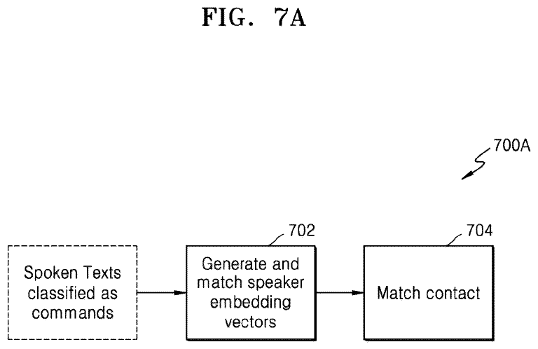

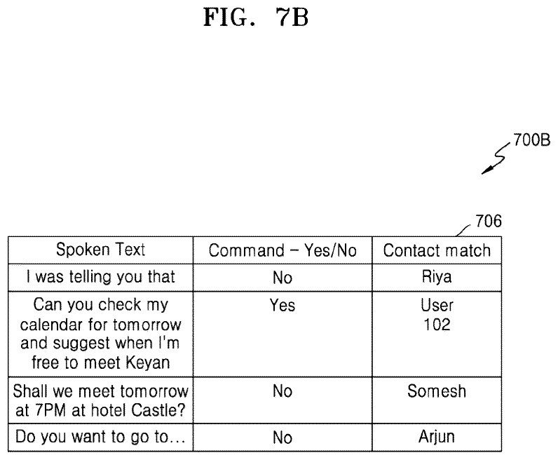

At block 312, the logic flow diagram 300 describes processing AI commands. In an embodiment, the processor 228 may cause the electronic device 222 to identify, from the spoken texts classified as commands, at least one spoken text that is spoken by the user 102 associated with the WAD 202. Upon identification of the at least one spoken text that is spoken by the user 102, the processor 228 in conjunction with the AI command processor 236 may configure the AI-based VA to execute at least one command associated with the at least one spoken text. A response generated by the AI-based VA may be played back to the user 102 through the WAD 202. The identification of the at least one spoken text being spoken by the user 102 is described herein in conjunction with FIG. 7A and FIG. 7B.

FIG. 7A depicts a logic flow diagram 700A for performing contact match, in accordance with an embodiment of the present disclosure.

At block 702, the logic flow diagram 700 describes generating and matching speaker embedding vectors. In an embodiment, the processor 228 may cause the electronic device 222 to generate speaker embeddings for the user 102 and the plurality of speakers 104-110 based on audio signals corresponding to the spoken texts. The generated speaker embeddings may be compared with the speaker embeddings received as part of the metadata 212 for aiding in contact match as performed at block 704.

At block 704, the logic flow diagram 700 describes performing contact match. In an embodiment, the generated speaker embeddings that match with the speaker embeddings received as part of the metadata 212 may be utilized by the processor 228 to identify the source (e.g., contact) associated with each of the matched speaker embeddings. In an embodiment, the processor 228 may compare the speaker embeddings with a plurality of speaker embeddings stored in a contact profile database associated with the electronic device 222. In an exemplary embodiment, the plurality of speaker embeddings stored in the contact profile database may be manufactured by processing speech signals during a call made from the electronic device 222 or received by the electronic device 222. In an embodiment, each stored speaker embedding may be associated with a person name in the contact profile database. Thus, by comparing the generated speaker embeddings with the stored plurality of speaker embeddings, the processor 228 may identify which of the spoken texts are spoken by the user 102 and which of the spoken texts are spoken by the one or more of the plurality of speakers 104-110. An exemplary illustration 700B of a contact match table 706 is depicted in FIG. 7B. FIG. 7B depicts a plurality of spoken texts amongst which the text-“Can you check my calendar for tomorrow and suggest when I'm free to meet Keyan?” is classified as a command while the other spoken texts such as “I was telling you that . . . ”, “Shall we meet tomorrow at 7 PM at hotel Castle?” and “Do you want to go to . . . ” are classified as conversation. By performing contact match as described herein, the processor 228 may identify that the command “Can you check my calendar for tomorrow and suggest when I'm free to meet Keyan?” is spoken by the user 102 associated with the WAD 202. Further, the processor 228 may identify that the spoken texts “I was telling you that . . . ”, “Shall we meet tomorrow at 7 PM at hotel Castle?” and “Do you want to go to . . . ” are spoken by Riya, Somesh and Arjun, respectively. Hence, upon performing contact match, the processor 228 may configure the AI-based VA to execute command associated with the spoken text “Can you check my calendar for tomorrow and suggest when I'm free to meet Keyan” and a response generated by the AI-based VA may be played back to the user 102 through the WAD 202 as described at block 312 of the logic flow diagram 300.

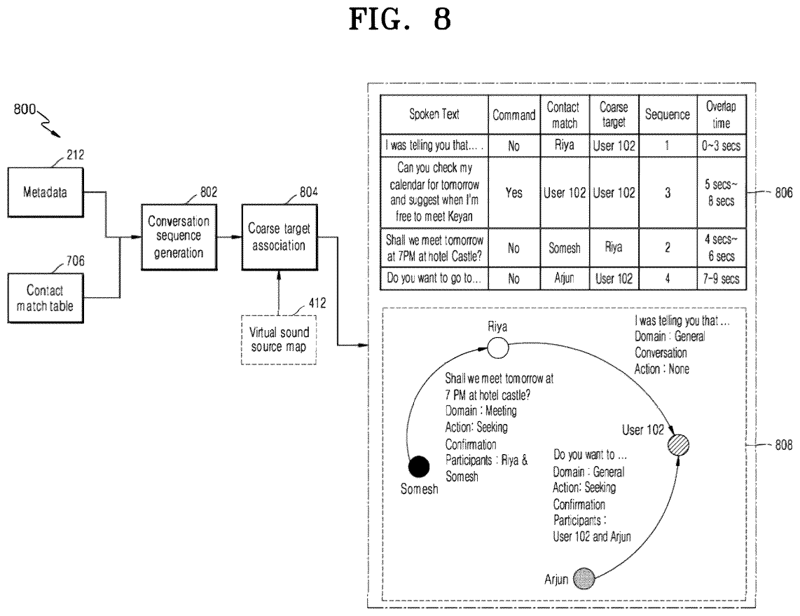

Referring again to FIG. 3, at block 314, the logic flow diagram 300 describes performing conversation sequence generation. In an embodiment, for the one or more spoken texts classified as a conversation, the processor 228 in conjunction with the conversation sequence generation module 238 may cause the electronic device 222 to generate a conversation sequence. The generation of conversation sequence is described in the forthcoming paragraphs in conjunction with FIG. 8.

FIG. 8 depicts a logic flow diagram 800 for generation of conversation sequence and coarse target association in accordance with an embodiment of the present disclosure.

At block 802, the logic flow diagram 800 describes generating a conversation sequence. In an embodiment, at block 802, the processor 228 may cause the electronic device 222 to utilize the metadata 212 received from the WAD 202 and tag each audio signal in the binaural audio signal (received as part of the metadata 212) based on the estimated speaker embedding vectors corresponding to the plurality of speakers 104-110. In an embodiment, the processor 228 may cause the electronic device 222 to utilize the tagged speaker embedding vectors in conjunction with the contact match table 706 to generate a conversation sequence. In an embodiment, the conversation sequence may include a sequence or an order in which each of the plurality of spoken texts are spoken and an overlap time between each of the plurality of spoken texts as depicted in a conversation sequence table 806. It may be noted by a skilled person that the conversation sequence may be generated either in the form of a table such as the conversation sequence table 806 or in the form of a graph or any other suitable means of information representation. In an embodiment, the processor 228 may cause the electronic device 222 to generate a conversation plan graph 808.

At block 804, the logic flow diagram describes performing coarse target association. In an embodiment, the processor 228 may cause the electronic device 222 to utilize the virtual sound map 412 and the user 102's head direction obtained as part of the metadata 212 to associate a target source with each of the plurality of spoken texts as depicted in the conversation sequence table 806 or the conversation plan graph 808. For instance, as illustrated in the conversation sequence table 806, the spoken text “I was telling you that . . . ” is spoken by Riya and is directed towards the user 102. On similar lines, the spoken texts “Shall we meet tomorrow at 7 PM at hotel Castle?” and “Do you want to go to . . . ” are spoken by Somesh and Arjun, respectively and directed towards Riya and the user 102, respectively.

Hence, based on the target sources estimated by the WAD202, the processor 228 of the electronic device 222 may consider the speakers—Riya and Arjun for audio enhancement. However, in order to verify the accuracy of the target estimation, the electronic device 222 may refine the target estimation in order to determine target sources for which audio management is to be performed. In particular, since within the WAD 202, the interaction of the user 102 with multiple speakers is judged only based on acoustic input, the target source estimation as performed by the WAD 202 may not be robust. Hence, the electronic device 222 may not just consider the acoustic signals, but also analyze the conversation sequence, amongst other vital inputs as described in the forthcoming paragraphs to refine the target estimation.

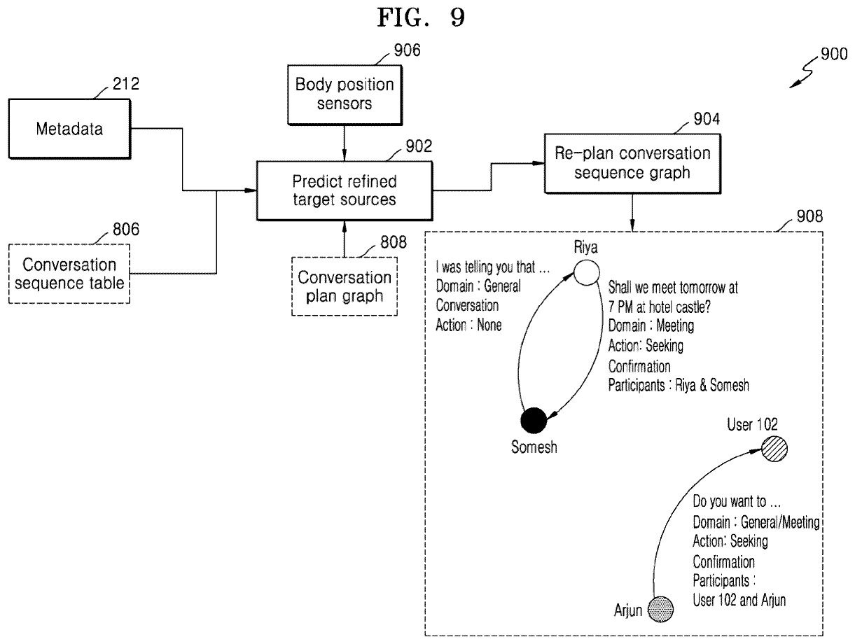

Referring again to FIG. 3, at block 316, the logic flow diagram 300 describes refining the estimation of the target sources. The refinement of the target source estimation is described in the upcoming paragraphs in conjunction with FIG. 9.

FIG. 9 depicts a logic flow diagram 900 for refining the target source estimation, in accordance with an embodiment of the present disclosure.

At block 902, the logic flow diagram 900 describes predicting refined target sources. In an embodiment, the processor 228 in conjunction with the target source refinement module 240 may cause the electronic device to estimate one or more refined target sources (or candidate target sources) based on an input. The input may include at least one of the generated conversation sequence graph 806, the generated conversation plan graph 808, the metadata 212, an interaction type of the user 102, or data from one or more body sensors 906 associated with the user 102. In an embodiment, the processor 228 in conjunction with the target source refinement module 240 may implement a deep neural network model that determines a score for each of the candidate target sources based on the input. Based on a result of comparing the scores with a threshold score, one or more candidate target sources may be identified as one or more refined target sources. In an embodiment, a pattern matching technique may be utilized by the processor 228 that uses the interaction timeline 600 to refine the target sources by analyzing historical interactions.

At block 904, the logic flow diagram 900 describes replanning the conversation plan graph. In an embodiment, the conversation plan graph 808 may be replanned by the processor 228 in conjunction with the target source refinement module 240 to generate an updated conversation plan graph 908.

Upon comparing the conversation plan graph 808 and the updated conversation plan graph 908, it is observed that according to the conversation plan graph 808, the user 102 may be supposed to focus on both Riya and Arjun's voice. However, the updated conversation plan graph 908 depicts that Riya is in conversation with Somesh and hence, the user 102 is required to only focus on Arjun's voice.

Referring again to FIG. 3, at block 318, the logic flow diagram 300 describes performing audio management. In an embodiment, upon the refinement of the target sources, the processor 228 in conjunction with the signal filter management module 242 may perform audio management of an audio signal based on the refined target sources. In an exemplary embodiment, performing audio management may include amplifying the audio signal associated with at least one refined target source with whom the user 102 is in direct conversation with. For instance, considering the example described in the preceding paragraphs, the processor 228 in conjunction with the signal filter management module 242 may amplify the audio signal associated with Arjun to generate a processed audio signal 320. In an embodiment, the processed audio signal 320 may be transmitted to the WAD 202.

In an exemplary embodiment, the processor 228 in conjunction with the signal filter management module 242 may cause the electronic device 222 to analyze whether an ongoing interaction (e.g., conversation amongst at least two refined target sources) is meaningful to the user 102. For instance, the processor 228 may judge that the interaction between Riya and Somesh is meaningful to the user, based on whether the user 102 is being referred to in their interaction or based on user-input. In such a scenario, the processor 228 in conjunction with the signal filter management module 242 may cause the electronic device 222 to manage (e.g., amplify) audio signals associated with Riya and Somesh that are interacting with each other. The processor 228, in conjunction with the signal filter management module 242, may cause the electronic device 222 to minimize the background noise to allow the user 102 to focus on the interaction between Riya and Somesh.

In an exemplary embodiment, the processor 228 in conjunction with the signal filter management module 242 may cause the electronic device 222 to modulate the audio signals of the refined target sources based on whether the refined target sources interact with the user 102. For instance, if the user 102 may be interacting with both Arjun and Somesh, the processor 228 in conjunction with the signal filter management module 242 may cause the electronic device 222 to amplify the audio signal associated with Arjun when Arjun is speaking and vice versa.

The WAD 202 (e.g., the WAD 202 and the electronic device 222) may allow audio management in a multi-speaker environment based on an understanding of the interaction context.

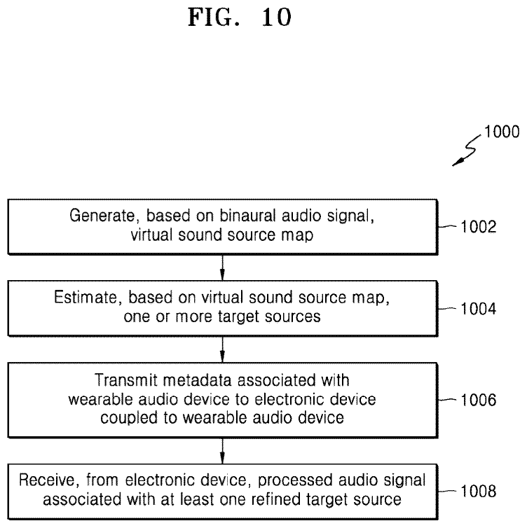

FIG. 10 depicts, by way of a flowchart, an exemplary method 1000 for managing audio in a multi-speaker environment, in accordance with an embodiment of the present disclosure. The method 1000 may be implemented at the WAD 202. The method 1000 may include one or more operations. The method 1000 may be described in the context of computer executable instructions. Computer executable instructions may include routines, programs, objects, components, data structures, procedures, modules, and functions, which perform particular functions or implement particular abstract data types.

Further, the order in which the method 1000 is described is not intended to be construed as a limitation, and any number of the described method blocks can be combined in any order to implement the method. Furthermore, the method can be implemented in any suitable hardware, software, firmware, or combination thereof.

At operation 1002, the method 1000 may include generating, based on a binaural audio signal captured by the WAD 202, a virtual sound source map 412 indicating a localized position of one or more sources of sound.

At operation 1004, the method 1000 may include estimating, based on the virtual sound source map 412, one or more target sources indicating sources of sound of interest to a user (102) of the WAD (202).

At operation 1006, the method 1000 may include transmitting metadata 212 associated with the WAD 202 to an electronic device 222 coupled to (e.g., connected with) the WAD 202 to cause the electronic device 222 to refine the one or more target sources based on the metadata 212.

At operation 1008, the method 1000 may include receiving from the electronic device 222, a processed audio signal 320 associated with at least one refined target source.

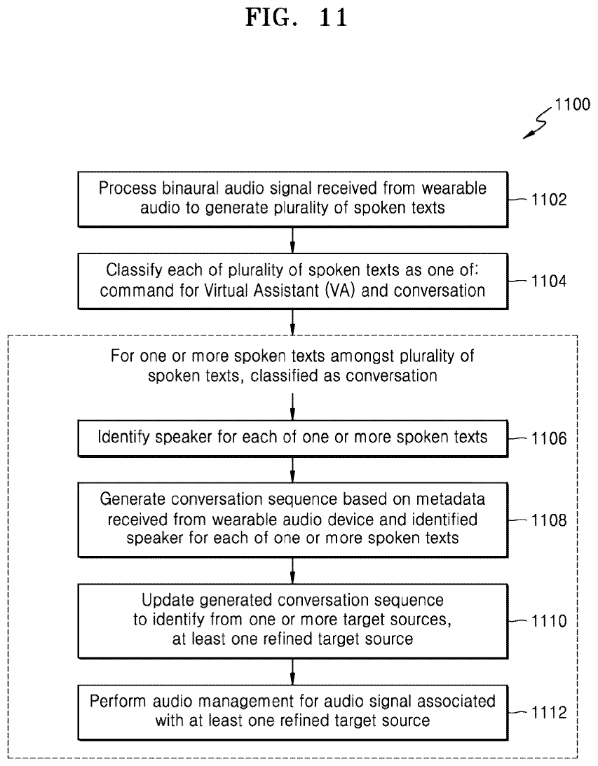

FIG. 11 depicts, by way of a flowchart, an exemplary method 1100 for managing audio in a multi-speaker environment, in accordance with an embodiment of the present disclosure. In an embodiment, method 1100 may be implemented at the electronic device 222. In an embodiment, one or more operations in method 1100 may be performed at the WAD 202. The method 1100 may comprise one or more operations. The method 1100 may be described in the context of computer executable instructions. Computer executable instructions may include routines, programs, objects, components, data structures, procedures, modules, and functions, which perform particular functions or implement particular abstract data types.

Further, the order in which the method 1100 is described is not intended to be construed as a limitation, and any number of the described method blocks can be combined in any order to implement the method. Furthermore, the method can be implemented in any suitable hardware, software, firmware, or combination thereof.

At operation 1102, the method 1100 may include processing the binaural audio signal received from the WAD 202 associated with a user 102 to generate a plurality of spoken texts.

At operation 1104, the method 1100 may include classifying each of the plurality of spoken texts as one of: a command for a Virtual Assistant (VA) and a conversation. For one or more spoken texts classified as a conversation, the method 1100 may proceed to operation 1106.

At operation 1106, the method 1100 may include identifying a speaker for each of the one or more spoken texts.

At operation 1108, the method 1100 may include generating a conversation sequence based on metadata 212 received from the WAD 202 and the identified speaker for each of the one or more spoken texts. In an embodiment, the conversation sequence may associate each of the one or more spoken texts with a target source among one or more target sources estimated by the WAD 202.

At operation 1110, the method 1100 may include updating the generated conversation sequence for identifying from the one or more target sources, at least one refined target source associated with each of the one or more spoken texts and data obtained from one or more body position sensors 906 associated with the user 102.

At operation 1112, the method 1100 may include performing audio management for an audio signal associated with the at least one refined target source.

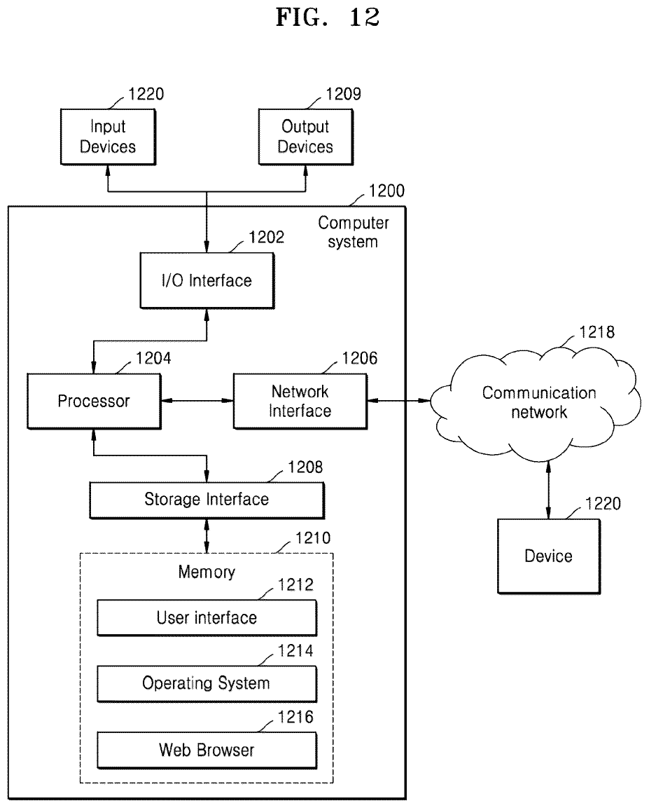

FIG. 12 illustrates a block diagram of an exemplary computer system 1200 for implementing an embodiment consistent with the present disclosure. In an embodiment, the computer system 1200 may be used to implement the WAD 202 and/or the mobile device 222. Thus, the computer system 1200 may be used for managing audio in a multi-speaker environment. The computer system 1200 may include a Central Processing Unit 1204 (also referred as “CPU” or “processor”). The processor 1204 may include at least one data processor. The processor 1204 may include specialized processing units such as integrated system (bus) controllers, memory management control units, floating point units, graphics processing units, digital signal processing units, etc.

The processor 1204 may be disposed in communication with one or more input/output (I/O) devices via I/O interface 1202. The I/O interface 1202 may employ communication protocols/methods such as, without limitation, audio, analog, digital, monoaural, RCA, stereo, IEEE (Institute of Electrical and Electronics Engineers)-1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 1016.n/b/g/n/x, Bluetooth, cellular (e.g., code-division multiple access (CDMA), high-speed packet access (HSPA+), global system for mobile communications (GSM), long-term evolution (LTE), WiMAX, or the like), etc.

Using the I/O interface 1202, the computer system 1200 may communicate with one or more I/O devices. For example, the input device 1220 may include an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 1222 may include a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The processor 1204 may be disposed in communication with the communication network 1218 via a network interface 1206. The network interface 1206 may communicate with the communication network 1218. The network interface 1206 may employ connection protocols including, without limitation, direct connect, Ethernet (e.g., twisted pair 10/100/1000 Base T), transmission control protocol/internet protocol (TCP/IP), token ring, IEEE 1016.11a/b/g/n/x, etc. The communication network 1218 may include, without limitation, a direct interconnection, local area network (LAN), wide area network (WAN), wireless network (e.g., using Wireless Application Protocol), the Internet, etc. The network interface 1206 may employ connection protocols including, but not limited to, direct connect, Ethernet (e.g., twisted pair 10/100/1000 Base T), transmission control protocol/internet protocol (TCP/IP), token ring, IEEE 1016.11a/b/g/n/x, etc. The computer system 1200 may be connected to a device 1220 through the communication network 1218. In an embodiment, the device 1220 may refer to the WAD 202, when the computer system is implemented as the electronic device 222. In an embodiment, the device 1220 may refer to the electronic device 222, when the computer system is implemented as the WAD 202.

The communication network 1218 may include, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In an embodiment, the processor 1204 may be disposed in communication with memory 1210 (e.g., RAM, ROM, etc.) via a storage interface 1208. The storage interface 1008 may connect to memory 1210 including, without limitation, memory drives, removable disc drives, etc., employing connection protocols such as serial advanced technology attachment (SATA), Integrated Drive Electronics (IDE), IEEE-1094, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 1210 may store a collection of program or database components, including, without limitation, user interface 1212, an operating system 1214, web browser 1216 etc. In an embodiment, computer system 1200 may store user/application data, such as, the data, variables, records, etc., as described in this disclosure. Such databases may be implemented as fault-tolerant, relational, scalable, secure databases such as Oracle® or Sybase®.

The operating system 1214 may facilitate resource management and operation of the computer system 1200. Examples of operating systems may include, without limitation, APPLE MACINTOSHR OS X, UNIXR, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLER IOS™, GOOGLER ANDROID™, BLACKBERRYR OS, or the like.

In an embodiment, the computer system 1200 may implement the web browser 1216 stored program component. The web browser 1216 may be a hypertext viewing application, for example MICROSOFTR INTERNET EXPLORER™, GOOGLER CHROMETMO, MOZILLAR FIREFOX™, APPLER SAFARI™, etc. Secure web browsing may be provided using Secure Hypertext Transport Protocol (HTTPS), Secure Sockets Layer (SSL), Transport Layer Security (TLS), etc. Web browsers 1216 may utilize facilities such as AJAX™, DHTML™, ADOBER FLASH™, JAVASCRIPT™, JAVA™, Application Programming Interfaces (APIs), etc. In an embodiment, the computer system 1200 may implement a mail server stored program component. The mail server may be an Internet mail server such as Microsoft Exchange, or the like. The mail server may utilize facilities such as ASP™, ACTIVEX™, ANSI™ C++/C#, MICROSOFTR, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFTR exchange, Post Office Protocol (POP), Simple Mail Transfer Protocol (SMTP), or the like. In an embodiment, the computer system 1200 may implement a mail client stored program component. The mail client may be a mail viewing application, such as APPLER MAIL™, MICROSOFTR ENTOURAGE™, MICROSOFTR OUTLOOK™, MOZILLAR THUNDERBIRD™, etc.

The illustrated operations are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed.

A description of an embodiment with several components in communication with each other does not imply that all such components are required. On the contrary a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices. The functionality and/or the features of a device may be embodied by one or more other devices which are not explicitly described as having such functionality/features. Thus, other embodiments of the disclosure need not include the device itself.

Finally, the language used in the specification has been selected for readability and instructional purposes. It is therefore intended that the scope of the disclosure be limited not by this detailed description, but rather by any claims that issue on an application based here on. Accordingly, the disclosure of an embodiment of the disclosure is intended to be illustrative, but not limiting, of the scope of the disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

In an embodiment, the present disclosure may provide a wearable audio device in communication with an electronic device (e.g., a mobile device) for managing audio in a multi-speaker environment.

In an embodiment, the present disclosure may intelligently alter playback of the surrounding environment sounds based on interaction context. In an embodiment, a method of managing audio in a multi-speaker environment, performed by a wearable audio device (202) may be provided. The method may include generating, based on a binaural audio signal captured by the wearable audio device (202), a virtual sound source map (412) indicating a localized position of one or more sources of sound. The method may include estimating, based on the virtual sound source map (412), one or more target sources indicating sources of sound of interest to a user (102) of the wearable audio device (202). The method may include transmitting metadata (212) associated with the wearable audio device (202), to an electronic device (222) coupled to the wearable audio device (202), to cause the electronic device (222) to refine the one or more target sources based on the metadata (212). The method may include receiving, from the electronic device (222), a processed audio signal (320) associated with at least one refined target source.

In an embodiment, the one or more sources of sound may include the user (102) of the wearable audio device (202) and one or more speakers in the multi-speaker environment.

In an embodiment, the generating the virtual sound source map (412) may include estimating a head movement of the user (102) based on data obtained from one or more head sensors (209) associated with the wearable audio device (202). The generating the virtual sound source map (412) may include determining relative positions of the one or more sources of sound with respect to the head movement of the user (102). The generating the virtual sound source map (412) may include computing horizontal offset angles and vertical offset angles for the one or more sources of sound. The generating the virtual sound source map (412) may include generating embedding vectors indicating identification of the one or more sources of sound. The generating the virtual sound source map (412) may include generating the virtual sound source map (412) based on the relative positions of the one or more sources of sound, the horizontal offset angles and the vertical offset angles, and the embedding vectors.

In an embodiment, the metadata (212) may include the virtual sound source map (412) and the one or more target sources.

In an embodiment, the estimating the one or more target sources may include estimating, based on the virtual sound source map (412), directions of conversation of the one or more sources of sound. The estimating the one or more target sources may include estimating a relative movement of a head of the user (102) with respect to an initial head position of the user (102). The estimating the one or more target sources may include monitoring one or more head gestures of the user (102) and classifying the one or more head gestures, the classification of the one or more head gestures comprising agreement gestures and disagreement gestures. The estimating the one or more target sources may include determining, using a target detection model (514), one or more sound source pairs between which a live interaction is present based on the directions of conversation. The estimating the one or more target sources may include generating, using the target detection model (514), an interaction timeline of the user (102) associated with the one or more sources of sound, based on the one or more sound source pairs, the relative movement, and the one or more head gestures. The interaction timeline may include a time duration and a type of interaction of the user (102) associated with the one or more sources of sound, and wherein the type of interaction includes: direct, indirect and passive. The estimating the one or more target sources may include estimating, using the target detection model (514), the one or more target sources based on the interaction timeline.

In an embodiment, the receiving the processed audio signal may include receiving an amplified audio signal associated with the at least one refined target source. The method may include playing back the amplified audio signal to the user (102) from the wearable audio device (202).

In an embodiment, the metadata (212) may include information corresponding to the binaural audio signal, the virtual sound source map (412), and an interaction timeline of the user (102).

In an embodiment, the generating the virtual sound source map (412) may include rendering and serializing the virtual sound source map (412) in a three-dimensional space. The estimating the one or more target sources may include estimating, using one or more head sensors (209) associated with the wearable audio device (202), one or more head gestures of the user (102). The estimating the one or more target sources may include generating the interaction timeline based on the one or more head gestures, a head position of the user (102), and a head direction of the user (102). The estimating the one or more target sources may include updating the one or more target sources in response to a change in the head direction of the user (102).

In an embodiment, the estimating the one or more target sources may include assigning, using a trained AI model, priorities to at least one source of sound based on a direction of conversation with respect to the user (102). The estimating the one or more target sources may include selecting the one or more target sources based on the priorities and the interaction timeline.

In an embodiment, the estimating the directions of conversation may include inputting, into a trained AI model, a head direction of the user (102) and directions of the one or more sources of sound from the virtual sound source map (412). The estimating the one or more target sources may include outputting, from the trained AI model, estimates of the directions of conversation for the one or more sources of sound.

In an embodiment, a wearable audio device (202) for managing audio in a multi-speaker environment may be provided. The wearable audio device may include a microphone (207), memory (210) storing instructions, and at least on processor (208). The instructions, when executed by the at least one processor (208), individually or collectively, may cause the wearable audio device to generate, based on a binaural audio signal captured by the microphone (207), a virtual sound source map (412) indicating a localized position of one or more sources of sound. The instructions, when executed by the at least one processor (208), individually or collectively, may cause the wearable audio device to estimate, based on the virtual sound source map (412), one or more target sources indicating sources of sound of interest to a user (102) of the wearable audio device (202). The instructions, when executed by the at least one processor (208), individually or collectively, may cause the wearable audio device to transmit metadata (212) associated with the wearable audio device (202) to an electronic device (222) coupled to the wearable audio device (202), to cause the electronic device (222) to refine the one or more target sources based on the metadata (212). The instructions, when executed by the at least one processor, individually or collectively, may cause the wearable audio device to receive, from the electronic device (222), a processed audio signal (320) associated with at least one refined target source.

In an embodiment, the instructions, when executed by the at least one processor (208), individually or collectively, may cause the wearable audio device (202) to estimate a head movement of the user (102) based on data obtained from one or more head sensors (209) associated with the wearable audio device (202). The instructions, when executed by the at least one processor (208), individually or collectively, may cause the wearable audio device to determine relative positions of the one or more sources of sound with respect to the head movement of the user (102). The instructions, when executed by the at least one processor (208), individually or collectively, may cause the wearable audio device to compute horizontal offset angles and vertical offset angles for the one or more sources of sound. The instructions, when executed by the at least one processor (208), individually or collectively, may cause the wearable audio device to generate embedding vectors indicating identification of the one or more sources of sound. The instructions, when executed by the at least one processor (208), individually or collectively, may cause the wearable audio device to generate the virtual sound source map (412) based on the relative positions of the one or more sound sources, the horizontal offset angles and the vertical offset angles, and the embedding vectors.

In an embodiment, the instructions, when executed by the at least one processor (208), individually or collectively, may cause the wearable audio device (202) to estimate, based on the virtual sound source map (412), directions of conversation of the one or more sources of sound. The instructions, when executed by the at least one processor (208), individually or collectively, may cause the wearable audio device to estimate a relative movement of a head of the user (102) with respect to an initial head position of the user (102). The instructions, when executed by the at least one processor (208), individually or collectively, may cause the wearable audio device to monitor one or more head gestures of the user (102) and classify the one or more head gestures, the classification of the one or more head gestures comprising agreement gestures and disagreement gestures. The instructions, when executed by the at least one processor (208), individually or collectively, may cause the wearable audio device to determine, using a target detection model (514), one or more sound source pairs between which a live interaction is present based on the directions of conversation. The instructions, when executed by the at least one processor (208), individually or collectively, may cause the wearable audio device to generate, using the target detection model (514), an interaction timeline of the user (102) associated with the one or more sources of sound, based on the one or more sound source pairs, the relative movement, and the one or more head gestures. The interaction timeline may include a time duration and a type of interaction of the user (102) associated with the one or more sources of sound. The type of interaction may include direct, indirect and passive. The instructions, when executed by the at least one processor (208), individually or collectively, may cause the wearable audio device to estimate, using the target detection model (514), the one or more target sources based on the interaction timeline.

In an embodiment, the instructions, when executed by the at least one processor (208), individually or collectively, may cause the wearable audio device (202) to receive, from the electronic device, an amplified audio signal associated with the at least one refined target source. The instructions, when executed by the at least one processor (208), individually or collectively, may cause the wearable audio device to play back the amplified audio signal to the user (102) from the wearable audio device (202).

In an embodiment, a computer-readable recording medium having at least one instruction recorded thereon, that, when executed by at least one processor (208), individually or collectively, may cause the wearable audio device (202) to perform the method.

In an embodiment, a computer-readable recording medium having at least one instruction recorded thereon, that, when executed by at least one processor, individually or collectively, may cause the wearable audio device to generate, based on a binaural audio signal captured by the microphone, a virtual sound source map indicating a localized position of one or more sources of sound. The at least one instruction, when executed by at least one processor, individually or collectively, may cause the wearable audio device to estimate one or more target sources. The at least one instruction, when executed by at least one processor, individually or collectively, may cause the wearable audio device to transmit metadata associated with the wearable audio device to an electronic device coupled to the wearable audio device to cause the electronic device to refine the one or more target sources based on the metadata. The at least one instruction, when executed by at least one processor, individually or collectively, may cause the wearable audio device to receive, from the electronic device, a processed audio signal associated with at least one refined target source.

In an embodiment, a method of managing audio in a multi-speaker environment, implemented at a mobile device may include processing (1102) a binaural audio signal received from a wearable audio device (202) associated with a user (102) to generate a plurality of spoken texts. The method may include classifying (1104) each of the plurality of spoken texts as one of: a command for a Virtual Assistant (VA) and a conversation. For one or more spoken texts amongst the plurality of spoken texts, classified as the conversation, the method may include identifying a speaker for each of the one or more spoken texts. The method may include generating a conversation sequence based on metadata (212) received from the wearable audio device (202) and the identified speaker for each of the one or more spoken texts, wherein the conversation sequence associates each of the one or more spoken texts with a target source of one or more target sources estimated by the wearable audio device. The method may include updating the generated conversation sequence for identifying from the one or more target sources, at least one refined target source associated with each of the one or more spoken texts based on the metadata (212) and data obtained from one or more body position sensors (906) associated with the user. The method may include performing audio management for an audio signal associated with the at least one refined target source.

In an embodiment, the method may include amplifying the audio signal associated with the at least one refined target source. The method may include transmitting the amplified audio signal to the wearable audio device (202).

In an embodiment, the conversation sequence may depict a sequence and an overlap time for each of the one or more spoken texts.

In an embodiment, the method may include identifying at least one spoken text amongst the remaining spoken texts, spoken by the user of the wearable audio device. The method may include executing, by the VA, at least one command associated with the at least one spoken text.

In an embodiment, the method may include analyzing the generated conversation sequence, the metadata (212), an interaction type of each of the one or more target sources with the user (102) of the wearable audio device (202), and the data obtained from one or more body position sensors (906) associated with the user (102). The method may include allocating a score to each of the one or more target sources based on the analysis. The method may include identifying at least one refined target source based on the allocated score, wherein the at least one refined target source has a score greater than a predefined threshold score.

In an embodiment, a mobile device for managing audio in a multi-speaker environment may include memory (230) storing instructions, and at least on processor (228). The instructions, when executed by the at least one processor (228), individually or collectively, may cause the mobile device to process a binaural audio signal received from a wearable audio device (202) associated with a user (102) to generate a plurality of spoken texts. The instructions, when executed by the at least one processor (228), individually or collectively, may cause the mobile device to classify each of the plurality of spoken texts as one of: a command for a Virtual Assistant (VA) and a conversation. For one or more spoken texts amongst the plurality of spoken texts, classified as the conversation, the instructions, when executed by the at least one processor (228), individually or collectively, may cause the mobile device to identify a speaker for each of the one or more spoken texts. The instructions, when executed by the at least one processor (228), individually or collectively, may cause the mobile device to generate a conversation sequence based on metadata (212) received from the wearable audio device (202) and the identified speaker for each of the one or more spoken texts, wherein the conversation sequence associates each of the one or more spoken texts with a target source of one or more target sources estimated by the wearable audio device. The instructions, when executed by the at least one processor (228), individually or collectively, may cause the mobile device to update the generated conversation sequence for identifying from the one or more target sources, at least one refined target source associated with each of the one or more spoken texts based on the metadata (212) and data obtained from one or more body position sensors (906) associated with the user. The instructions, when executed by the at least one processor (228), individually or collectively, may cause the mobile device to perform audio management for an audio signal associated with the at least one refined target source.

In an embodiment, the instructions, when executed by the at least one processor (228), individually or collectively, may cause the mobile device to amplify the audio signal associated with the at least one refined target source. The instructions, when executed by the at least one processor (228), individually or collectively, may cause the mobile device to transmit the amplified audio signal to the wearable audio device.

In an embodiment, the conversation sequence may depict a sequence and an overlap time for each of the one or more spoken texts.

In an embodiment, the instructions, when executed by the at least one processor (228), individually or collectively, may cause the mobile device to identify at least one spoken text amongst the remaining spoken texts, spoken by the user of the wearable audio device. The instructions, when executed by the at least one processor (228), individually or collectively, may cause the mobile device to execute, by the VA, at least one command associated with the at least one spoken text.

In an embodiment, the instructions, when executed by the at least one processor (228), individually or collectively, may cause the mobile device to analyze the generated conversation sequence, the metadata (212), an interaction type of each of the one or more target sources with the user (102) of the wearable audio device (202), and the data obtained from one or more body position sensors (906) associated with the user (102). The instructions, when executed by the at least one processor (228), individually or collectively, may cause the mobile device to allocate a score to each of the one or more target sources based on the analysis. The instructions, when executed by the at least one processor (228), individually or collectively, may cause the mobile device to identify at least one refined target source based on the allocated score, wherein the at least one refined target source has a score greater than a predefined threshold score.

What is claimed is:

1. A method of managing audio in a multi-speaker environment, performed by a wearable audio device, the method comprising:
generating, based on a binaural audio signal captured by the wearable audio device, a virtual sound source map indicating a localized position of one or more sources of sound;
estimating, based on the virtual sound source map, one or more target sources indicating sources of sound of interest to a user of the wearable audio device;
transmitting metadata associated with the wearable audio device, to an electronic device coupled to the wearable audio device, to cause the electronic device to refine the one or more target sources based on the metadata; and
receiving, from the electronic device, a processed audio signal associated with at least one refined target source.

2. The method of claim 1, wherein the one or more sources of sound comprise the user of the wearable audio device and one or more speakers in the multi-speaker environment.

3. The method of claim 1, wherein the generating the virtual sound source map comprises:
estimating a head movement of the user based on data obtained from one or more head sensors associated with the wearable audio device;
determining relative positions of the one or more sources of sound with respect to the head movement of the user;
computing horizontal offset angles and vertical offset angles for the one or more sources of sound;
generating embedding vectors indicating identification of the one or more sources of sound; and
generating the virtual sound source map based on:
the relative positions of the one or more sources of sound,
the horizontal offset angles and the vertical offset angles, and
the embedding vectors.

4. The method of claim 1, wherein the metadata comprises the virtual sound source map and the one or more target sources.

5. The method of claim 1, wherein the estimating the one or more target sources comprises:
estimating, based on the virtual sound source map, directions of conversation of the one or more sources of sound;
estimating a relative movement of a head of the user with respect to an initial head position of the user;
monitoring one or more head gestures of the user and classifying the one or more head gestures, the classification of the one or more head gestures comprising agreement gestures and disagreement gestures;
determining, using a target detection model, one or more sound source pairs between which a live interaction is present based on the directions of conversation;
generating, using the target detection model, an interaction timeline of the user associated with the one or more sources of sound, based on the one or more sound source pairs, the relative movement, and the one or more head gestures,
wherein the interaction timeline comprises a time duration and a type of interaction of the user associated with the one or more sources of sound, and wherein the type of interaction includes: direct, indirect and passive; and
estimating, using the target detection model, the one or more target sources based on the interaction timeline.

6. The method of claim 1, wherein the receiving the processed audio signal comprises receiving an amplified audio signal associated with the at least one refined target source, and wherein the method further comprises playing back the amplified audio signal to the user from the wearable audio device.

7. The method of claim 1, wherein the metadata comprises information corresponding to the binaural audio signal, the virtual sound source map, and an interaction timeline of the user.

8. The method of claim 5, wherein the generating the virtual sound source map comprises rendering and serializing the virtual sound source map in a three-dimensional space, and
wherein the estimating the one or more target sources comprises:
estimating, using one or more head sensors associated with the wearable audio device, one or more head gestures of the user;
generating the interaction timeline based on the one or more head gestures, a head position of the user, and a head direction of the user; and
updating the one or more target sources in response to a change in the head direction of the user.

9. The method of claim 8,
wherein the estimating the one or more target sources comprises:
assigning, using a trained AI model, priorities to at least one source of sound based on a direction of conversation with respect to the user; and
selecting the one or more target sources based on the priorities and the interaction timeline.

10. The method of claim 5, wherein the estimating the directions of conversation comprises:
inputting, into a trained AI model, a head direction of the user (102) and directions of the one or more sources of sound from the virtual sound source map (412); and
outputting, from the trained AI model, estimates of the directions of conversation for the one or more sources of sound.

11. A wearable audio device for managing audio in a multi-speaker environment, the wearable audio device comprising:
a microphone;
memory storing instructions; and
at least on processor;
wherein the instructions, when executed by the at least one processor, individually or collectively, cause the wearable audio device to:
generate, based on a binaural audio signal captured by the microphone, a virtual sound source map indicating a localized position of one or more sources of sound;
estimate one or more target sources;
transmit metadata associated with the wearable audio device to an electronic device coupled to the wearable audio device to cause the electronic device to refine the one or more target sources based on the metadata; and
receive, from the electronic device, a processed audio signal associated with at least one refined target source.

12. The wearable audio device as claimed in claim 11, wherein the one or more sources of sound comprise the user of the wearable audio device and one or more speakers in the multi-speaker environment.

13. The wearable audio device of claim 11, wherein the instructions, when executed by the at least one processor, individually or collectively, cause the wearable audio device to:
estimate a head movement of the user based on data obtained from one or more head sensors associated with the wearable audio device;
determine relative positions of the one or more sources of sound with respect to the head movement of the user;
compute horizontal offset angles and vertical offset angles for the one or more sources of sound;
generate embedding vectors indicating identification of the one or more sources of sound; and
generate the virtual sound source map based on:
the relative positions of the one or more sound sources,
the horizontal offset angles and the vertical offset angles, and
the embedding vectors.

14. The wearable audio device of claim 11, wherein the metadata comprises the virtual sound source map and the one or more target sources.

15. The wearable audio device of claim 11, wherein the instructions, when executed by the at least one processor, individually or collectively, cause the wearable audio device to:
estimate, based on the virtual sound source map, directions of conversation of the one or more sources of sound;
estimate a relative movement of a head of the user with respect to an initial head position of the user;
monitor one or more head gestures of the user and classify the one or more head gestures, the classification of the one or more head gestures comprising agreement gestures and disagreement gestures;
determine, using a target detection model, one or more sound source pairs between which a live interaction is present based on the directions of conversation;
generate, using the target detection model, an interaction timeline of the user associated with the one or more sources of sound, based on the one or more sound source pairs, the relative movement, and the one or more head gestures,
wherein the interaction timeline comprises a time duration and a type of interaction of the user associated with the one or more sources of sound, and wherein the type of interaction includes: direct, indirect and passive; and
estimate, using the target detection model, the one or more target sources based on the interaction timeline.

16. The wearable audio device of claim 11, wherein the instructions, when executed by the at least one processor, individually or collectively, cause the wearable audio device to:
receive, from the electronic device, an amplified audio signal associated with the at least one refined target source; and
play back the amplified audio signal to the user from the wearable audio device.

17. The wearable audio device of claim 11, wherein the metadata comprises information corresponding to the binaural audio signal, the virtual sound source map, and an interaction timeline of the user.

18. The wearable audio device of claim 11, wherein the instructions, when executed by the at least one processor, individually or collectively, cause the wearable audio device to:
render and serialize the virtual sound source map in a three-dimensional space;
estimate, using one or more head sensors associated with the wearable audio device, one or more head gestures of the user;
generate the interaction timeline based on the one or more head gestures, a head position of the user, and a head direction of the user; and
update the one or more target sources in response to a change in the head direction of the user.

19. The wearable audio device of claim 18, wherein the instructions, when executed by the at least one processor, individually or collectively, cause the wearable audio device to:
assign, using a trained AI model, priorities to at least one source of sound based on a direction of conversation with respect to the user; and
select the one or more target sources based on the priorities and the interaction timeline.

20. A non-transitory computer-readable recording medium having at least one instruction recorded thereon, that, when executed by at least one processor, individually or collectively, cause the wearable audio device to:
generate, based on a binaural audio signal captured by the microphone, a virtual sound source map indicating a localized position of one or more sources of sound;
estimate one or more target sources;
transmit metadata associated with the wearable audio device to an electronic device coupled to the wearable audio device to cause the electronic device to refine the one or more target sources based on the metadata; and
receive, from the electronic device, a processed audio signal associated with at least one refined target source.
